(19) United States
(12) Patent Application Publication
(10) Pub. No.: US 2015/0311992 A1
(43) Pub. Date: Oct. 29, 2015

(54) SYSTEM AND METHOD FOR REAL-TIME VIEWER FEEDBACK TO BROADCAST MEDIA

(71) Applicant: TOUCHED LLC, Los Angeles, CA (US)

(72) Inventors: Andrew F.T. Aston, Santa Clarita, CA (US); John A. Smid, Toronto (CA); Pao Yuan Chen, Toronto (CA)

(73) Assignee: TOUCHED LLC, Los Angeles, CA (US)

(21) Appl. No.: 14/261,009

(22) Filed: Apr. 24, 2014

(51) Int. Cl. H04H 60/33; H04N 21/426; H04N 21/81; H04N 21/475

(52) U.S. Cl. CPC H04H 60/33; H04N 21/4758; H04N 21/42653; H04N 21/8173

(57) ABSTRACT

A system and method for real-time viewer feedback during a live broadcast for a large number of users communicating through smart phones, tablets, laptop computers or desktop computers. In response to a solicitation by the broadcast, the users provide information through an internet connection to a data-collecting server. A rendering software solution on a media server converts the information into synchronized fill and key channels resulting in an intelligent graphics file. The synchronized fill and key channels are communicated to a media mixer that also controls the live broadcast. The accumulated viewer information is presented as a graphic and integrated into the live broadcast in real time. Alternatively, the live broadcast is altered is some other way based on the accumulated information provided by the viewers.

### FIELD OF THE INVENTION

This patent application relates in general to systems and methods for viewers to provide real-time feedback or information during a live broadcast to otherwise interact with broadcast media during a program. More specifically, it relates to real-time viewer communication with broadcast media during a live broadcast and polling of viewer opinions or solicitation of information to display as part of the broadcast or to modify the broadcast.

### BACKGROUND

In the past, television viewers could interact with television programs during a broadcast by submitting information through the internet (i.e., vote on a website) and telecommunications networks (i.e., vote by phone). To display the information as part of the live broadcast, or to modify the format or other attribute of the live broadcast according to the information provided, the information needed to be manually transferred and/or manipulated. For example, information provided by viewers would be collected in a database and made accessible to a broadcast system by manually transferring the collected data from the database to the broadcast outlet. Subsequently, the information needed to be manually converted into a format for graphical display compatible with the live broadcast and broadcast station. In addition, the data that is received by these systems requires a person to manually access the data and manually input the data into a graphics file. The need for multiple manual interventions creates significant delays between the time the viewer provides the information and the display of the information as part of the live broadcast, or modification of the live broadcast according to the information provided by the viewer. This delay detracts from the viewers' engagement and enjoyment of the program.

Moreover, past methods of obtaining viewer feedback in real time were vulnerable to attempts of a single source to provide multiple votes (or other responses). For example, a political candidate or commercial interest may want to create an impression that more viewers have a certain favorite, like or dislike than actually reflects the participating viewers. Such efforts can unduly skew the results, damage the credibility of the solicited information or polling, and reduce the quality of the participant and viewer experience.

Prior systems also do not enable real-time manipulation of on-air graphics by viewers using their mobile devices. One example of a prior system implementation includes a viewer poll for a live musical competition television show. Viewers are prompted to phone in a vote, text a vote, or enter a vote for a particular contestant via a website. Because of the manual and inefficient nature of the prior system, delivery of results of the viewer polls is delayed for a day or longer. Also, such systems do not have a reliable way to authenticate voters. As a result, meaningful results are subject to multiple votes by a single viewer. Prior systems have a limited ability to control viewer interactions in a meaningful way (e.g., prior systems cannot create usage rules and permissions that dictate voting protocol, such as one vote per user).

### SUMMARY

The embodiments provided herein are directed to systems and methods for en mass, real-time viewer feedback to broadcast media for on-air display or to modify a program. The systems, methods, features and advantages of the invention will be apparent to one with skill in the art upon examination of the following figures and detailed description. It is intended that all such additional methods, features and advantages be included within this description, be within the scope of the invention, and be protected by the accompanying claims. It is also intended that the invention is not limited to require the details of the example embodiments.

The present system includes a real-time connection between the mobile phone and on-air graphics without delays. This prevents the need for a producer, or another person, to transfer data into a graphic generator template before launching the output on-air. The present system utilizes a computer program containing an intelligent graphics file that is programmed to change its state in real-time. This avoids the need to manually enter data into a template and subsequently, manually output it in graphical form. As a result, a television viewer can submit information through their mobile device to broadcast media and influence the on-screen graphic in real-time.

Another feature enabled by the present system includes customizable actions. The intelligent graphics file of the present system can read and interpret data in limitless ways, and translate the data into a custom action. For example, a live tug-of-war is enabled wherein data collected from millions of mobile phones is translated by the intelligent graphics file and broadcast in real-time to the television screen and is displayed as a dynamic tug-of-war graphic to reflect the results as the data arrives.

The present disclosure addresses the authentication problem posed in prior systems, and enables automation of action based on user input in order to provide a faster, more reliable experience.

### BRIEF DESCRIPTION OF THE DRAWINGS

The accompanying drawings, which are included as part of the present specification, illustrate the presently preferred embodiment and, together with the general description given above and the detailed description of the preferred embodiment given below, serve to explain and teach the principles of the present invention.

FIGS. 1A-1E illustrate exemplary components and their relative interaction in the present system, according to one embodiment.

FIG. 2A illustrates an exemplary mobile application download method for use with the present system, according to one embodiment.

FIG. 2B illustrates an exemplary website registration method for use with the present system, according to one embodiment.

FIG. 2C illustrates an exemplary method for mobile device's interaction with the data-collecting server to be used in the present system, according to one embodiment.

FIG. 2D illustrates an exemplary method for a computer's interaction with a database server to be used in the present system, according to one embodiment.

FIG. 2E illustrates an exemplary method for authentication used in the present system, according to one embodiment.

FIG. 3 illustrates an exemplary method for a data-collecting server used in the present system, according to one embodiment.

FIG. 4 illustrates an exemplary method for intelligent graphics file used in the present system, according to one embodiment.

FIG. 5 illustrates an exemplary method for a media server used in the present system, according to one embodiment.

FIGS. 6A-6D illustrate exemplary mobile application displays and interfaces used in the present system, according to one embodiment.

FIGS. 7A-7J illustrate exemplary television displays and interfaces used in the present system, according to one embodiment.

FIGS. 8A-8J illustrate exemplary system administrator displays and interfaces used in the present system, according to one embodiment.

FIG. 9 illustrates exemplary components and their relative interaction for a computer containing the database server used in the present system, according to one embodiment.

It should be noted that the figures are not necessarily drawn to scale and that elements of similar structures or functions are generally represented by like reference numerals for illustrative purposes throughout the figures. It also should be noted that the figures are only intended to facilitate the description of the various embodiments described herein. The figures do not necessarily describe every aspect of the teachings disclosed herein and do not limit the scope of the claims.

### DETAILED DESCRIPTION OF THE PREFERRED EMBODIMENTS

The embodiments provided herein are directed to systems and methods for enabling viewers of broadcast mass media to provide real-time input of information during the broadcast. The input can either be displayed in a summary or graphical form, or used to modify the broadcast according to the viewer input. The systems and methods described and claimed herein avoid the need for substantial manual manipulation or transfer of information, thereby automating substantial portions of the system and method. This reduces the time from viewer input to display or broadcast manipulation dependent upon the viewer input. The reduction in time increases viewer attention and participation as the viewer does not have a substantial wait after inputting information, votes, or opinions, until the display or modification occurs. The causation between viewer input and the result becomes substantially more apparent, and more gratifying, to the viewer.

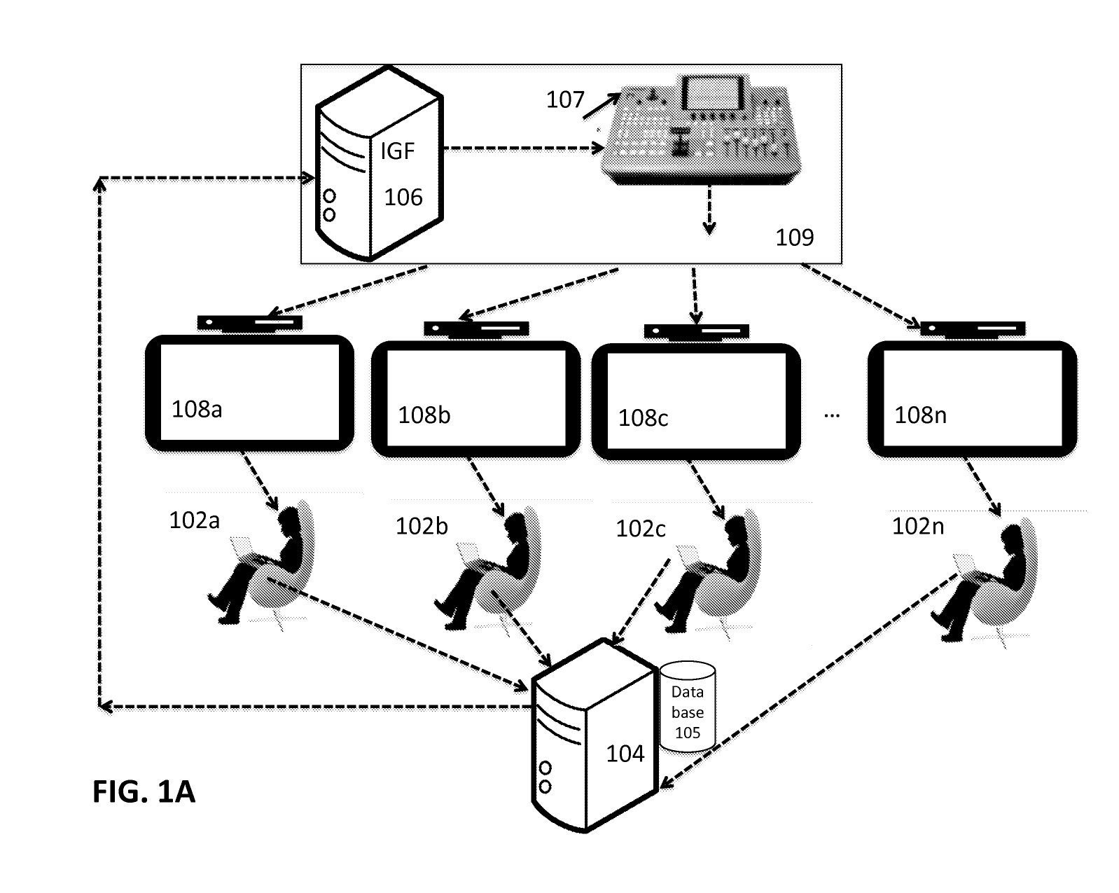

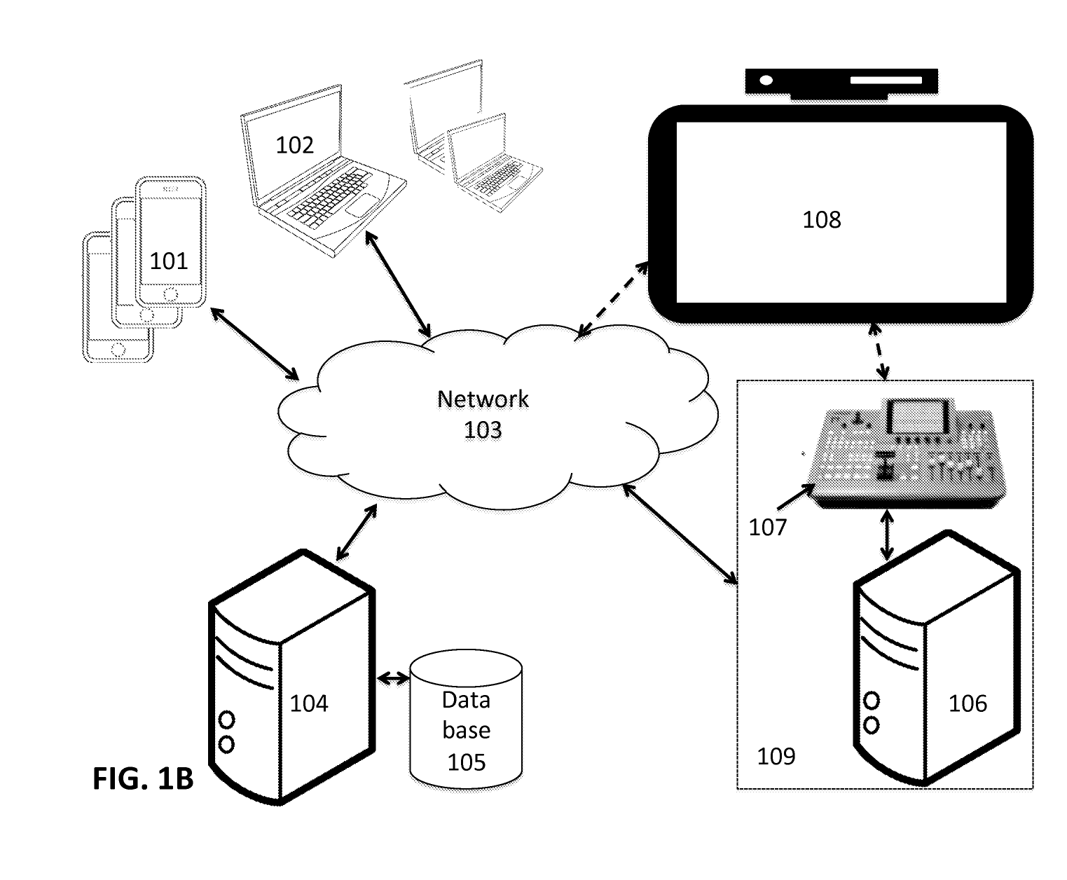

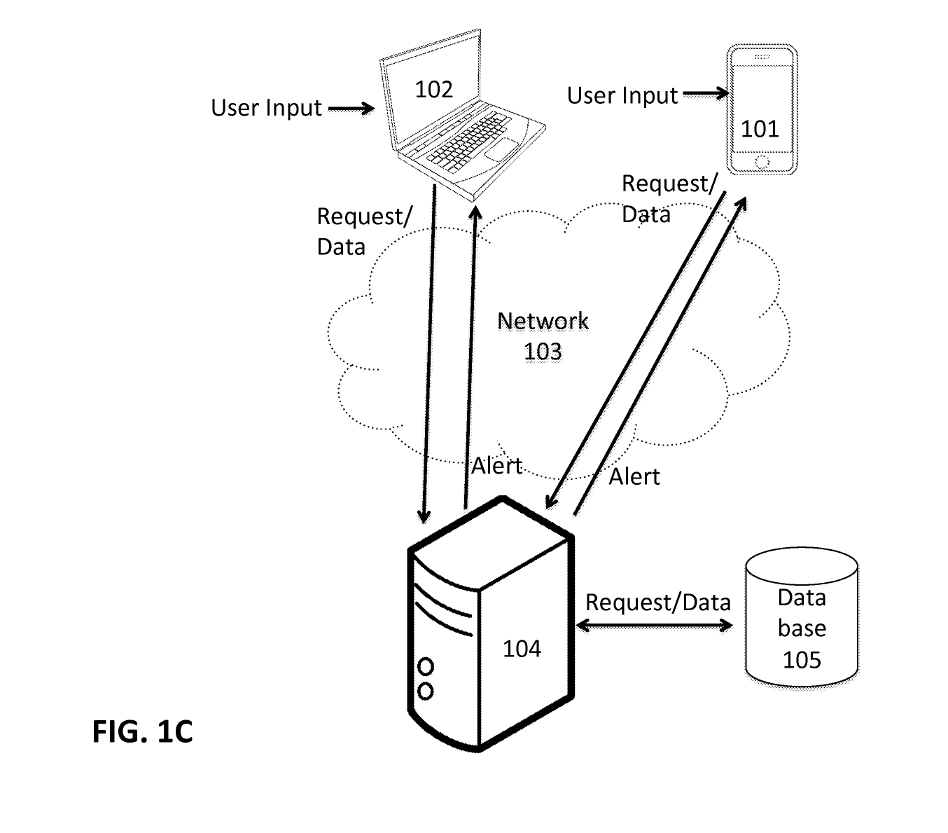

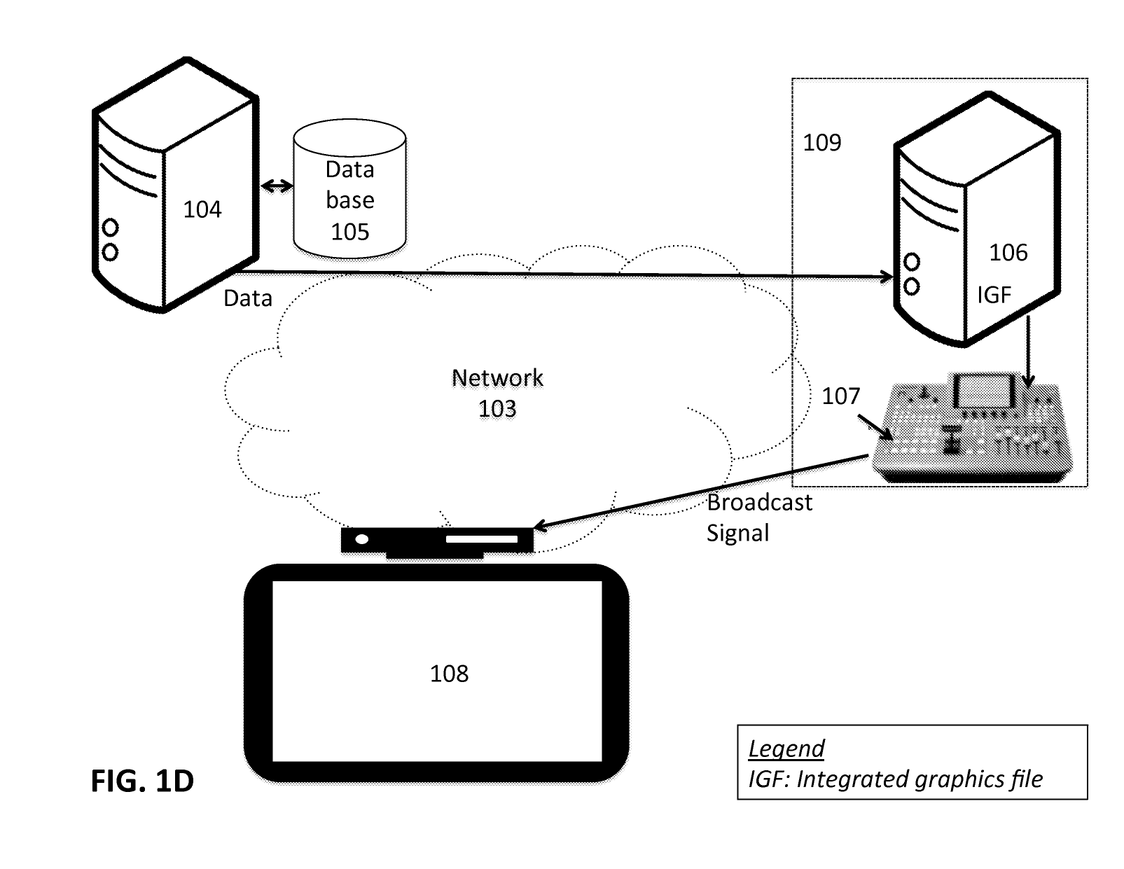

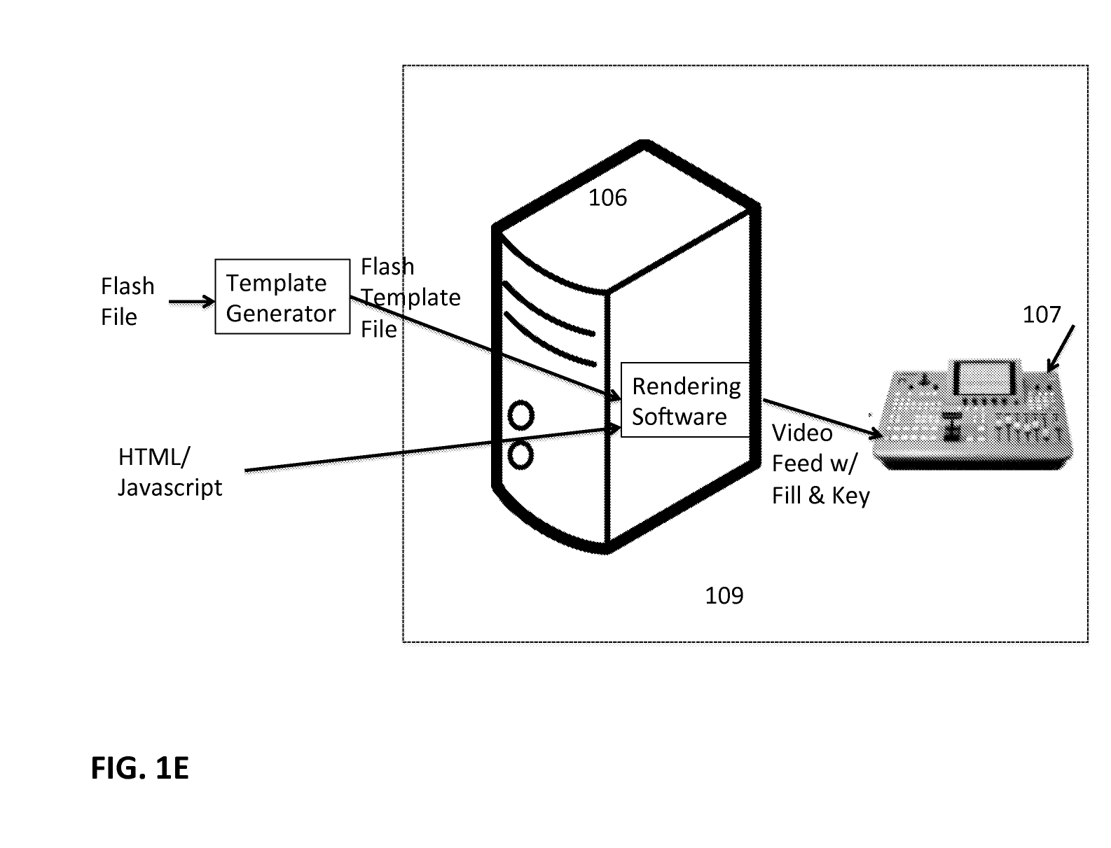

FIGS. 1A-1E illustrate exemplary components and their interaction as contemplated in the present system, according to one embodiment. The components include a mobile device 101, such as a smart phone or laptop computer, a website displayed on a computer 102, a network 103, a remote data-collecting server 104 including or associated with a database 105. The components also include a media server location 109, a template generator server 106 and mixer 107 (or other suitable mixing means). The broadcast media is displayed for the viewer on a television screen 108.

Generally, viewers (a-n, where n can be 10, 1000, 1 million, etc.) of broadcast media using this system and method also have access to the internet through mobile devices 101 (such as a smart phone or tablet) or laptop or desktop computers 102. The internet or other network connection 103 connects the viewers to the remote data-collecting server 104, which in-turn is integrated, associated or otherwise connected to a database 105. Large numbers of viewers will have nearly simultaneous input to the data-collecting server 104, which organizes the incoming information and stores it in the database 105.

The en mass viewer information, now accumulated in the database 105 and under the control of the data-collecting server 104 and stored in the database 105, is communicated to the media server location. If the media server location 109 is remote to the data server, the information can be communicated through an internet or other network connection 103. Alternatively, the data-collecting server 104 and database 105 are in the same or similar location as the media server location 109. The media server 106 at the media server location 109 is in communication with the data-collecting server 104 and receives information from the data-collecting server 104.

A specially formatted file on the media server 106 manipulates the information received from the data-collecting server 104 as described in more detail below. In general, the information is put into a desired graphical form and translated into a format that is compatible with downstream components in the system, enabling the data to control or influence a graphic (static or animated) in a desired manner. The information, as manipulated by the media server 106, is then further communicated to the mixer 107, which may be, but not necessarily, at the media server location 109. The mixer 107 incorporates the output from the media server 106 into the broadcast stream for the program. The output, which includes real-time data-controlled graphics, is then displayed in the desired format as part of the broadcast seen by viewers, those that participated in the polling or not, on the television screen 108. Alternatively, the aspects of the broadcast are modified according to the dictates of a majority or a plurality of the polled viewers.

One contemplated embodiment of the present system operates according to the following steps. First, a live broadcast on broadcast media solicits or polls the opinions, votes, interests, or other information of its viewers. In response, one or more viewers provide input to an (previously downloaded) application on a mobile device 101 or a website displayed on a computer 102. The mobile application and/or website acts to submit user information via a network 103 to remote data-collecting servers 104 having databases 105.

The remote data-collecting server or servers 104 receives the interaction data comprising a request and associated data, and validates and stores the request and data. A request is a message that contains instructions about how to retrieve or update information sent from a client (e.g. a mobile device) to the server 104. As part of the instructions, there may be data attached. After the server processes the request, a response that contains the result (success or failure) and the requested information is sent back to the client.

When processing requests, the server 104 validates information received by performing the following steps:
Inspect the data retrieval or update instructions and check if the instructions can be understood. If the instructions cannot be understood, return an error response.
If the instructions require the sender to be authenticated, then verify the user identity (e.g. by checking the session token sent along with the instructions). If the sender of the instructions cannot be authenticated, return an error response.
Follow the instructions to retrieve or update information and, depending on the instructions, perform additional validation if necessary. For example, if a vote is to be submitted, verify that the sender has not voted for the same poll previously.

The remote data-collecting server creates an intelligent graphics file (“IGF”) which is programmed to retrieve data and to perform an action based on the data/information, and transforms the accumulated viewer information into summary and graphic form.

The IGF is transmitted through the internet, or other digital means, to a media server 106 located in media server location 109. The system's rendering software installed on media server 106, reformats the IGF to add key and fill channels, and then outputs the reformatted IGF as a video feed to mixer 107. The mixer 107, also at the media server location 109, mixes the video feed with zero or more feeds from other sources, and then outputs the mixed feed into a live broadcast.

The live broadcast is streamed to viewer television screens 108 in real-time, typically as part of the live broadcast that solicited information from the viewers earlier in the program. Since the intelligent graphics file contains software code that translates the viewer information into an action, and the resultant action is streamed in real-time to the video mixer, the action can be viewed in real-time by the viewer on their television screen 108 while the participating viewers are still watching the program. Examples of an action include, but are not limited to, screen splitting, changing color, resizing, rotating, displaying voting results, and playing a selected video from a plurality of options.

It will be appreciated that the system is specifically designed to operate under conditions including a large input of information over a very short period of time from a large number of users watching the live broadcast from a large number of locations remote to one another. It will also be appreciated that the remote data-collecting server/servers 104 can be web servers or simple computers. The computing devices described herein (e.g. mobile device/tablet 101, computer 102, servers 104, server 106) can be of any design necessary to implement the capabilities described herein.

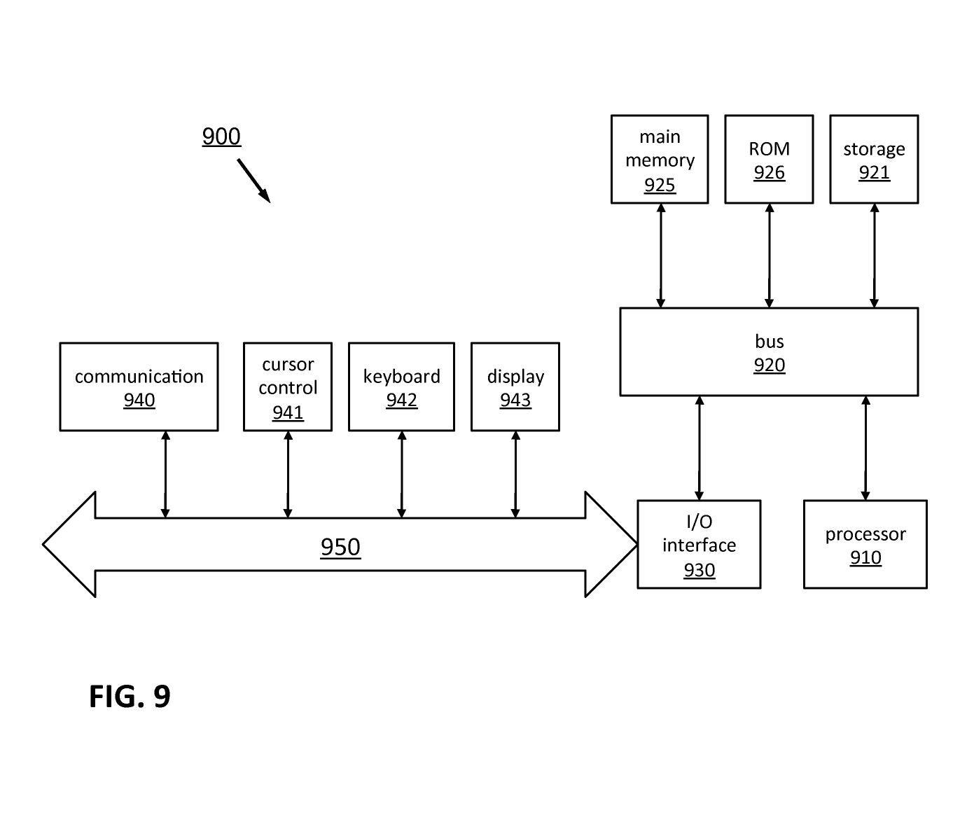

According to one embodiment, one or more of the computing devices has an exemplary architecture depicted in FIG. 9 and its accompanying description. Communication occurs over the network 103, in one embodiment, via HTTP, and messages are formatted according to JavaScript Object Notation (“JSON”). Although the communication between the media server 106 and the mixer 107 is a direct physical connection via serial digital interface (“SDI”), it will be appreciated that any appropriate form of communication that achieves the features disclosed herein can be used without departing from the scope of the present disclosure.

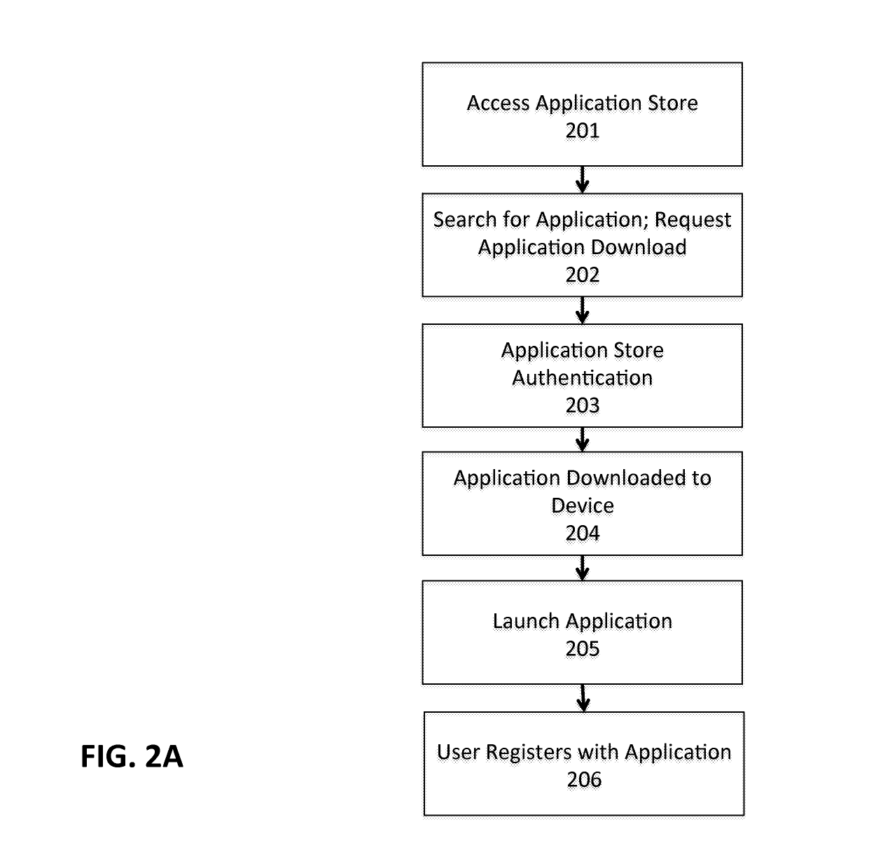

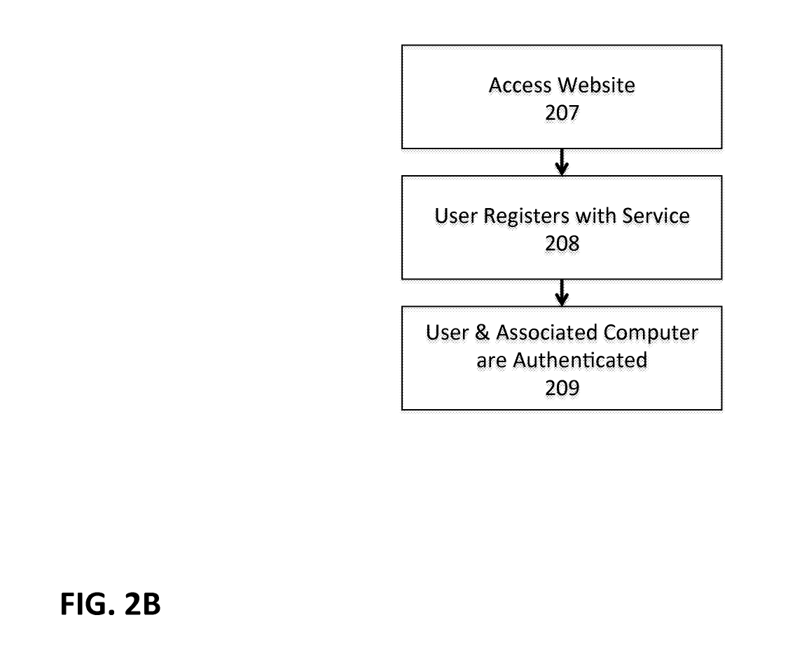

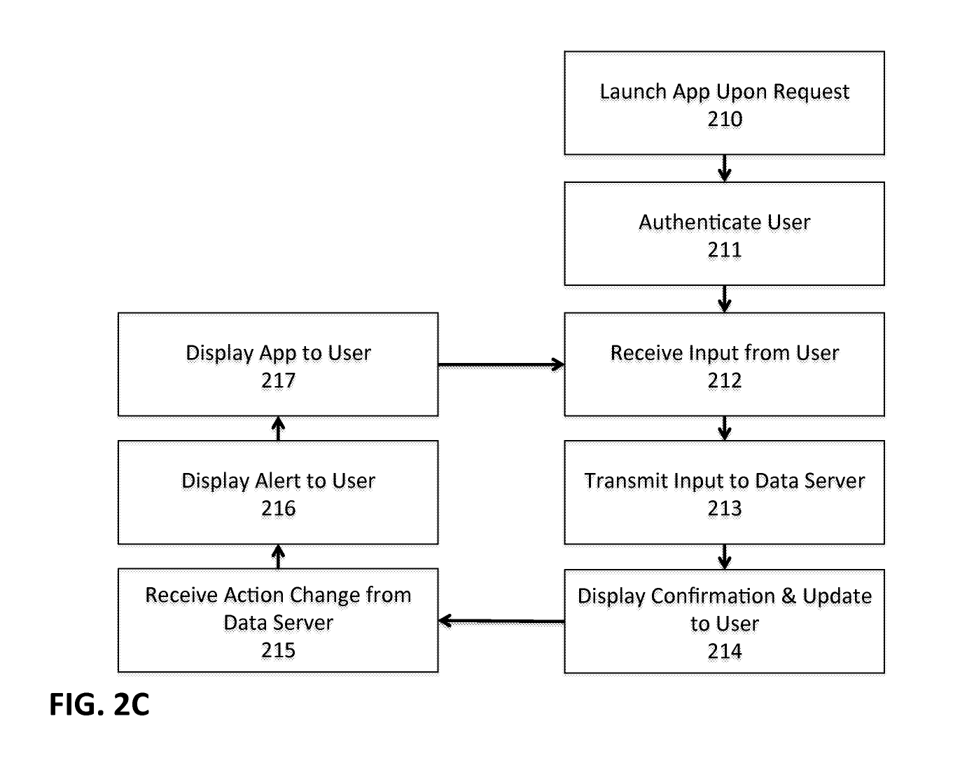

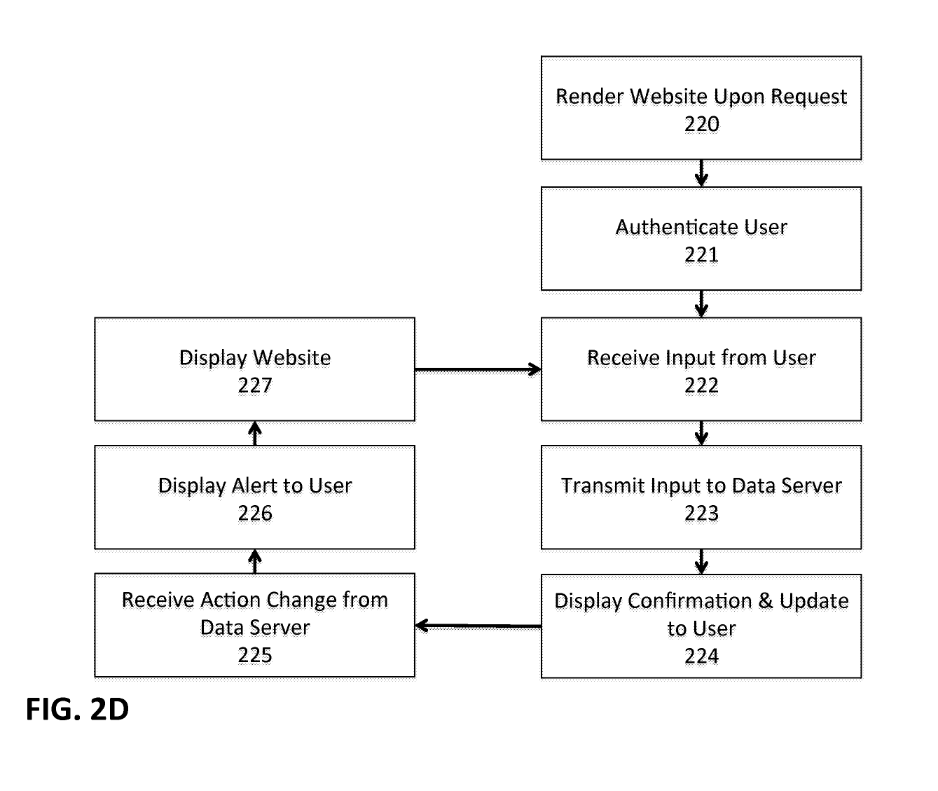

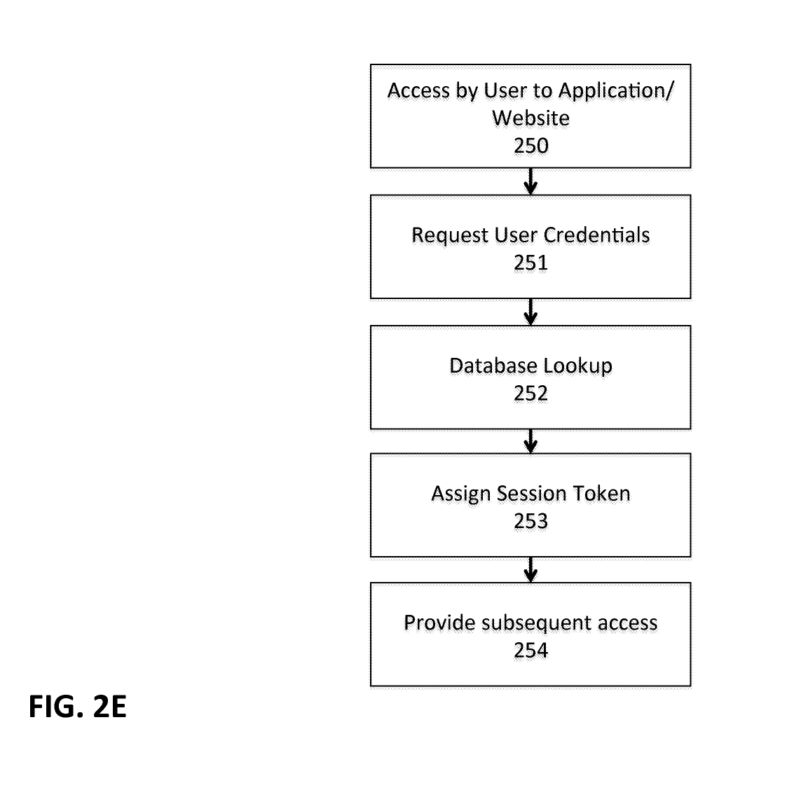

FIG. 2A illustrates exemplary method steps for downloading a mobile application as contemplated for use in the present system, according to one embodiment. A user accesses 201 an application store using a mobile computing device, searches for an application and requests 202 for the application to be downloaded to the mobile computing device. The application store authenticates 203 the user and device, and the application is downloaded 204 to the device. The user launches 205 the application and registers 206 with the application.

FIG. 2B illustrates exemplary method steps for the website registration used in the present system, according to one embodiment. A user, on a computer, accesses 207 a website using a browser. The user registers 208 with the service provided on the website. The user and the computer are authenticated 209 by the service.

It will be appreciated that a user might already be registered via another means (e.g. created an account online, or if the service is integrated with a third-party application, the user could use an account associated with the third-party application). In this case the user account authenticates via another means (e.g. login or variable passed from third-party app to present server).

FIG. 2C illustrates exemplary method steps for the mobile application interaction used in the present system, according to one embodiment. The mobile application is launched 210 upon request on the computing device. The user is authenticated 211, and the user interacts with the application. Input is received 212 from the user, and the input is transmitted 213 to a data-collecting server. Any confirmation and/or updates are displayed 214 within the application to the user of the device. Upon receipt 215 of any action change from the data-collecting server, an additional alert is displayed 216. The user then revisits the newly re-displayed 217 application in order to continue interacting with the application (e.g. the application may have been minimized on the mobile device).

The user can interact with and provide new input to be again received 212 by the application in a variety of ways, including touching, tapping, swiping, turning the device, etc.

FIG. 2D illustrates exemplary method steps for the website interaction used in the present system, according to one embodiment. A user on a computer visits a website using a browser, and the website is rendered 220 upon request. The user is authenticated 221, and the user then interacts with the website. Input is received 222 from the user, and the data is transmitted 223 to a data-collecting server. Any confirmation and/or updates are displayed 224 within the website or browser to the user of the computer. Upon receipt 225 of any action change from the data-collecting server, an additional alert is displayed 226. The user then revisits the displayed website 227 in order to continue interacting with the website (e.g., the browser may have been minimized on the computer).

FIG. 2E illustrates exemplary method steps for the user authentication method used in the present system, according to one embodiment. A user accesses 250 an application or website, and is prompted or requested 251 to enter user credentials. Upon receipt of the credentials, a database lookup 252 is performed and a session token is assigned 253. Subsequently, the authenticated user is provided with access 254.

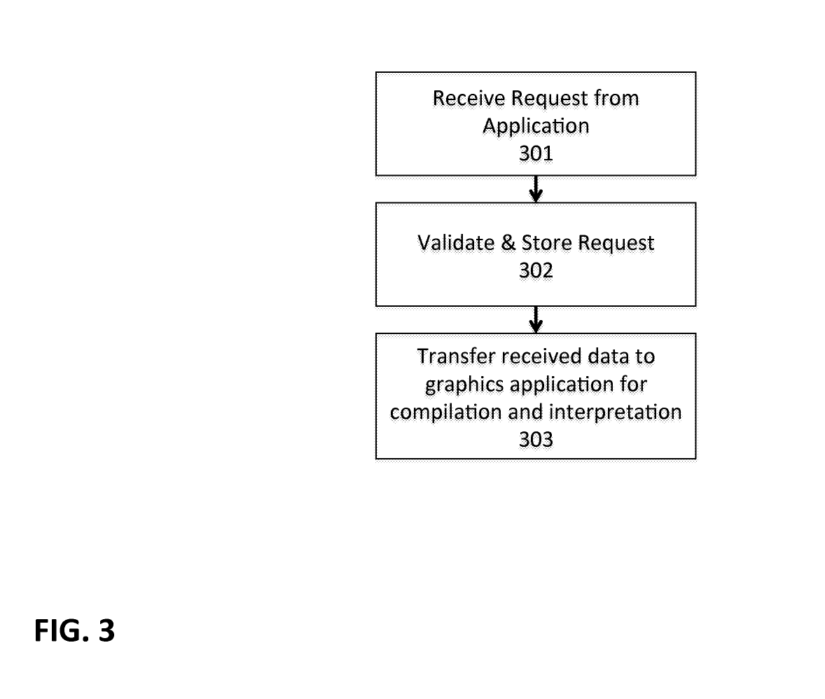

FIG. 3 illustrates an exemplary data-collecting server method for use with the present system, according to one embodiment. A request including data is received 301 from a mobile device having an application installed thereon, or from a website. The request is validated 302 and stored in a database, and any data received is aggregated and transferred 303 to a graphics application for compilation and interpretation. The data comprises, for example, information related to a user's submission or request and the user's session token that was generated during an authentication method. A session token is a unique identifier that is generated and sent from the server to the user's device to identify the user's interaction session. The reason to use session tokens is that the user's device only has to handle the identifier (a small piece of data which is otherwise meaningless and thus presents no security risk). The actual session data is stored on the server that the user's device does not have direct access to. The session token is simply an identifier that links the user's activity to the data that is collected.

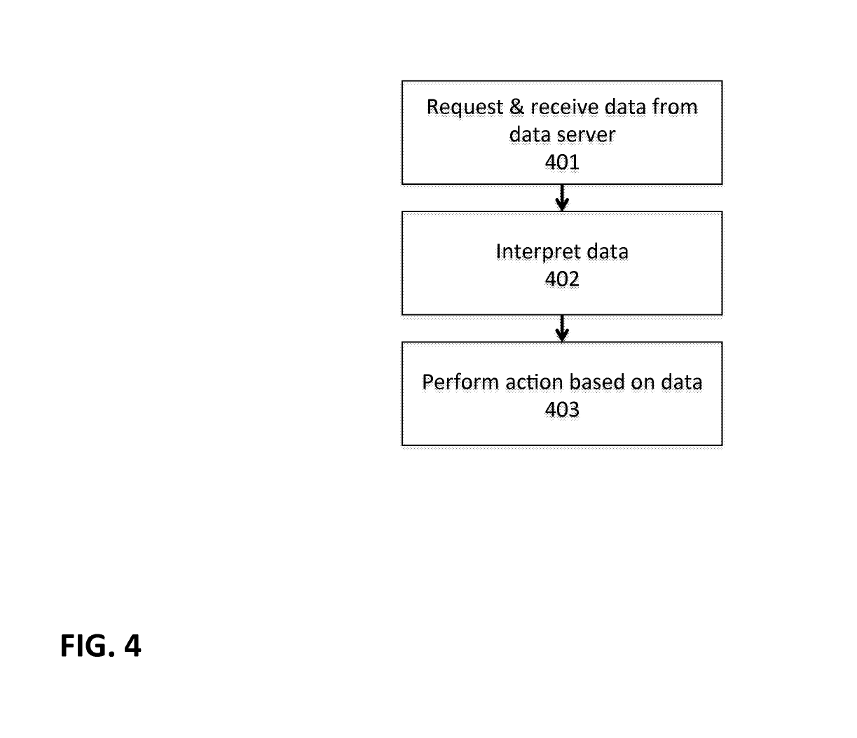

FIG. 4 illustrates exemplary method steps for the intelligent graphics file used in the present system, according to one embodiment. A template generator, at a media server, requests and receives 401 data from the data-collecting server. The template generator interprets 402 the data resulting in an intelligent graphics file. The intelligent graphics file is coded to perform an action 403 based on every possible outcome of the data interpretation.

According to one embodiment, interpretation occurs through action-script. The script contains logical statements that maps received data to actions. For example, “if data received is ≧50 then turn an image blue” or “if data X is <50 then rotate the circle clockwise, unless data Y=100.” The received data is a trigger for a prescribed action.

According to one embodiment, the intelligent graphics file can be a modified Flash template file, which is a Flash or SWF file that has gone through a template generator. The template generator injects code into the original Flash project, compiles it and converts the file to a modified Flash file template format. This makes the file compatible with software installed on the media server. The modified Flash template file is output with “key” and “fill” properties so that it can be streamed to the mixer.

According to one embodiment, the present graphics file is intended to occupy only a portion of the television screen. However, if the original graphics file (i.e., Flash file) is streamed “as is” into a mixer using a Flash Player, it occupies and is displayed over the entire screen, blocking out the other portions of the broadcast program. The reason for this is that Flash Player output only allows for “fill” channels that display over the entire visual space. Flash Player output does not provide for the graphics to be displayed on a portion of the visual space to allow the programming to simultaneously occupy the remaining space. To solve this, rendering software is used to output synchronized “fill” and “key” channels of a given Flash file. By providing an output with a key channel, the video feed indicates to the mixer which pixels are transparent. This allows the mixer to feed other video sources into the transparent areas of the screen.

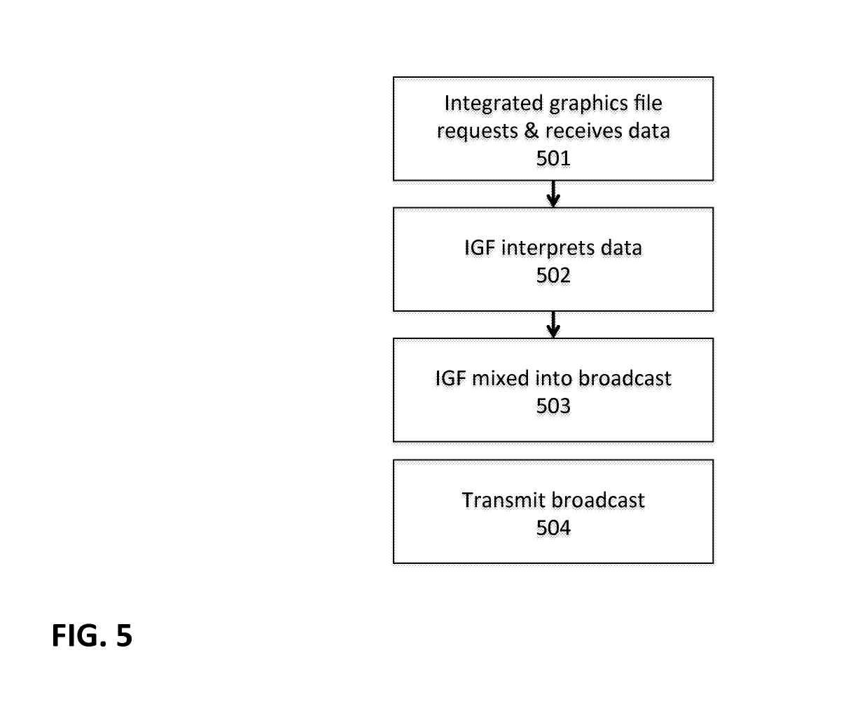

FIG. 5 illustrates exemplary method steps for the media server used in the present system, according to one embodiment. An integrated graphics file requests and receives 501 data from a data-collecting server. The intelligent graphics file interprets 502 the data as described above, which results in the intelligent graphics file being programmed to perform an action based on the data. The intelligent graphics file is mixed 503 into a broadcast, and the broadcast is transmitted 504 for display. According to one embodiment, a broadcast system administrator at the media server location can deploy the intelligent graphics file manually, or schedule it to go live automatically at a future time. The administrator outputs the intelligent graphics file (IGF) and launches it as a video output.

The IGF is a file that contains source assets and metadata. The IGF can be prepared using a compiler or created manually. For example, the source assets can be predominantly HTML, Javascript, CSS, images, or SWF, or another language. The compiler, resident on any server or computer, receives uploaded source assets and metadata, compiles them, and creates the IGF file including source assets, user-generated metadata, and other metadata that enables the rendering software to identify the file and its components.

When the IGF is uploaded to the rendering software, the rendering software reads the source code and its components and runs the source assets. It sends the resultant imagery, animation, and action controls as a fill channel to a video output interface (for example, an SDI interface) that receives the fill channel, generates the key channel and outputs a multi-channel feed (key+fill) to the mixer.

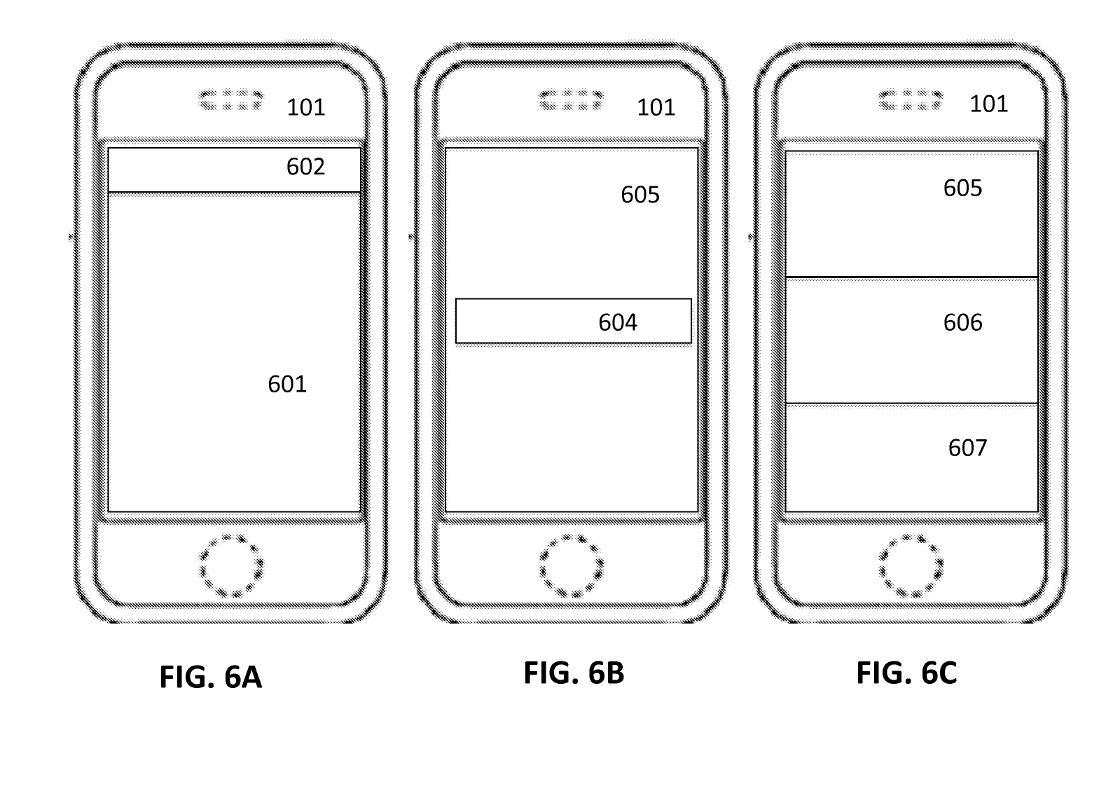

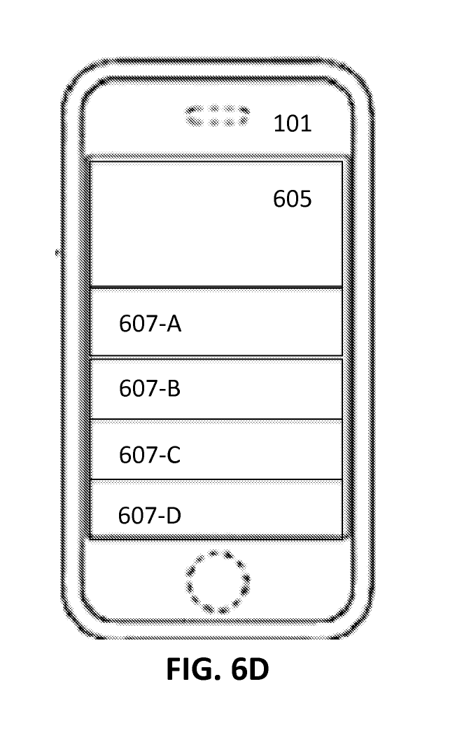

FIGS. 6A-6D illustrate exemplary mobile application interfaces used in the present system, according to one embodiment. An exemplary mobile application is installed on a mobile computing device 101. An exemplary interface includes a home screen 601, and a banner area 602. The banner area 602 may comprise an alert from an installed application. Once launched, an installed application may occupy the entire display 605 and have occasional alerts 604 laid over the display. If user input is solicited, for example as part of a poll, poll options are displayed as portions 606, 607 over entire display 605. A poll may comprise 4 options for voting selection, 607-A, 607-B, 607-C, 607-D. It will be appreciated that the user input can be something other than responding to a poll, as referenced above. Touching the screen at the indicated places registers a vote. An alert is any notification sent to the viewer's device; it can be a push notification to a mobile device, or simply appear as a pop-up.

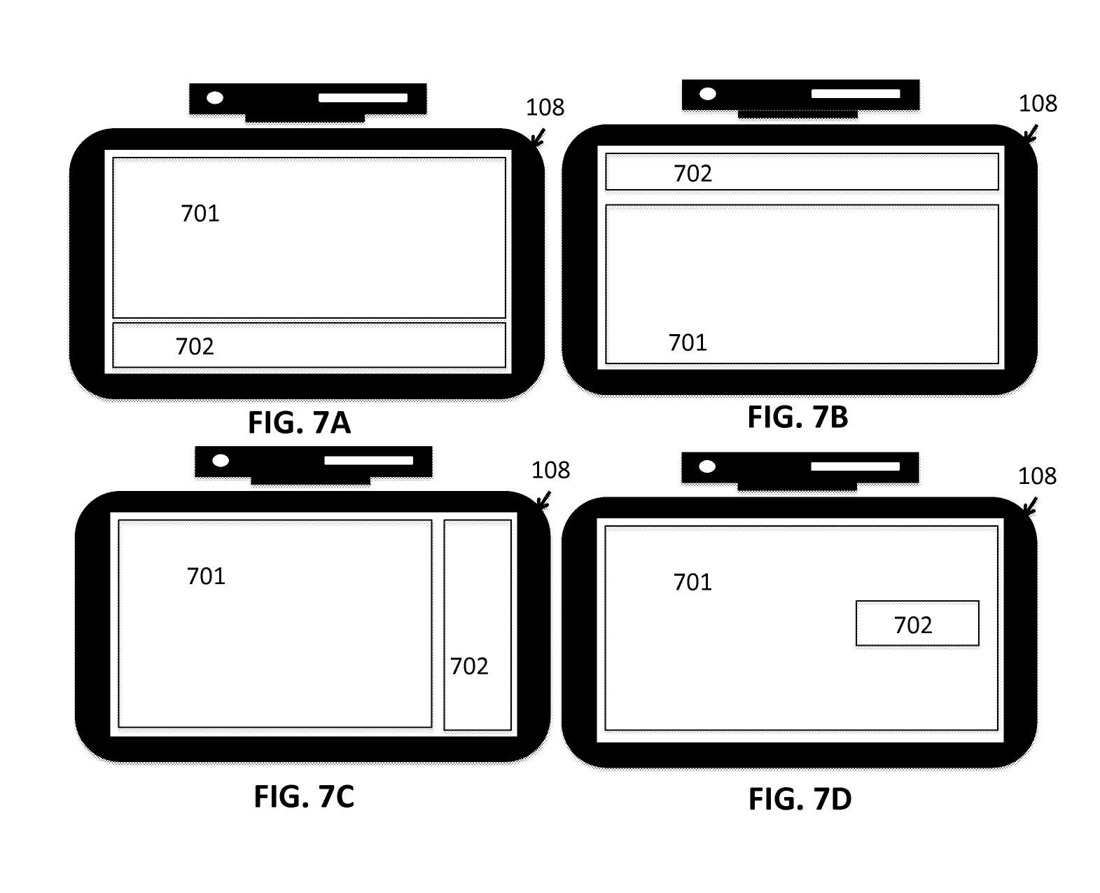

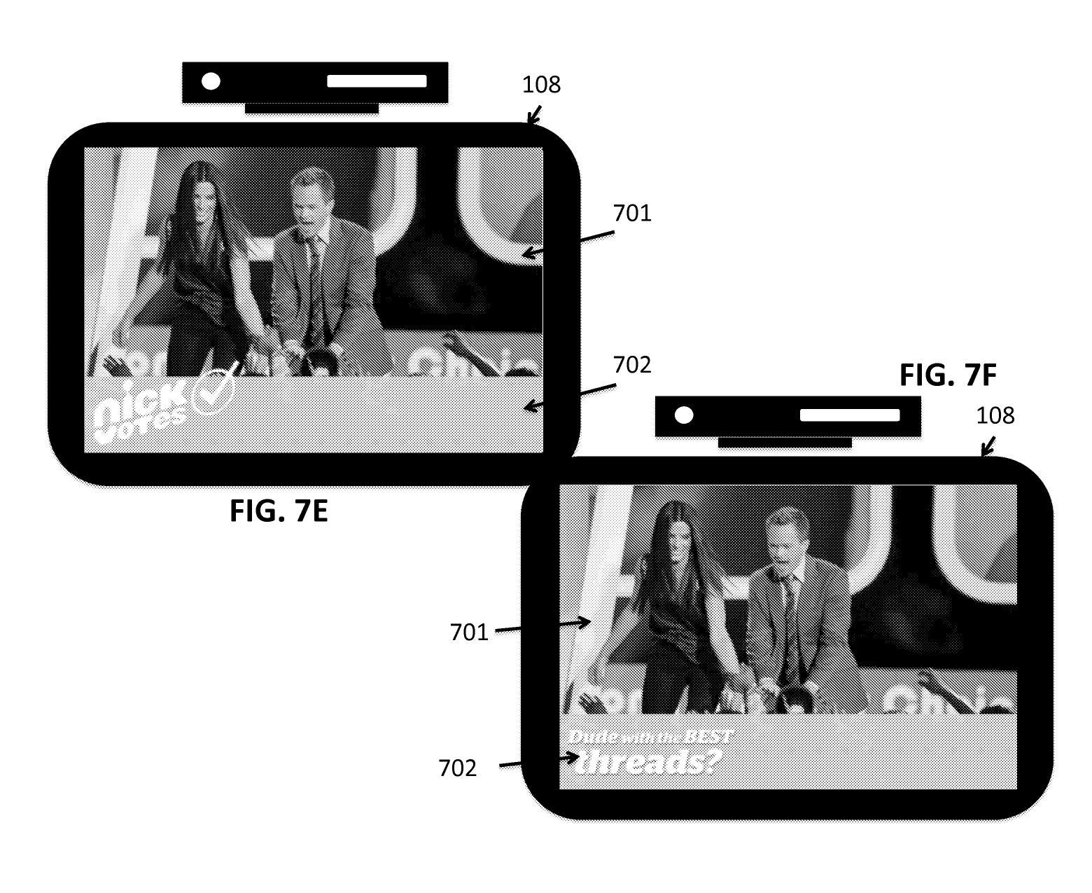

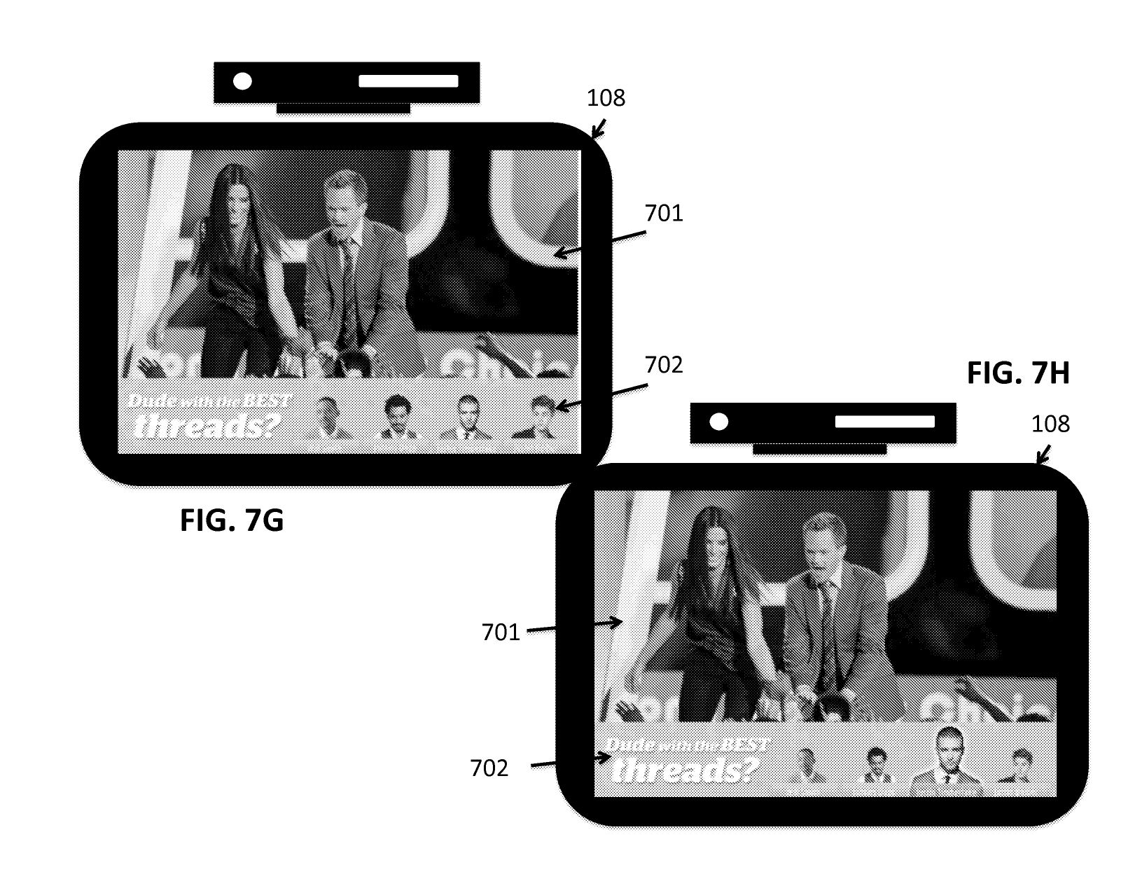

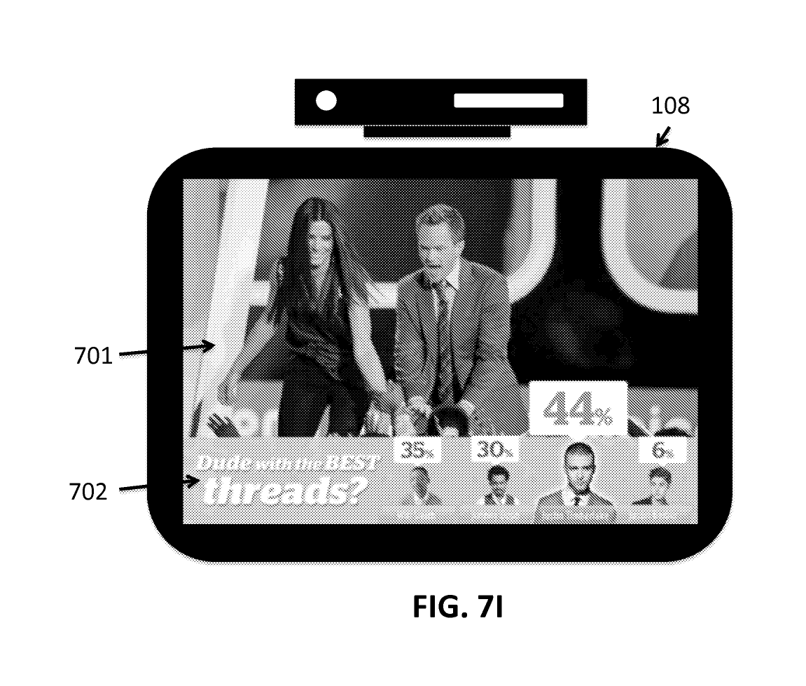

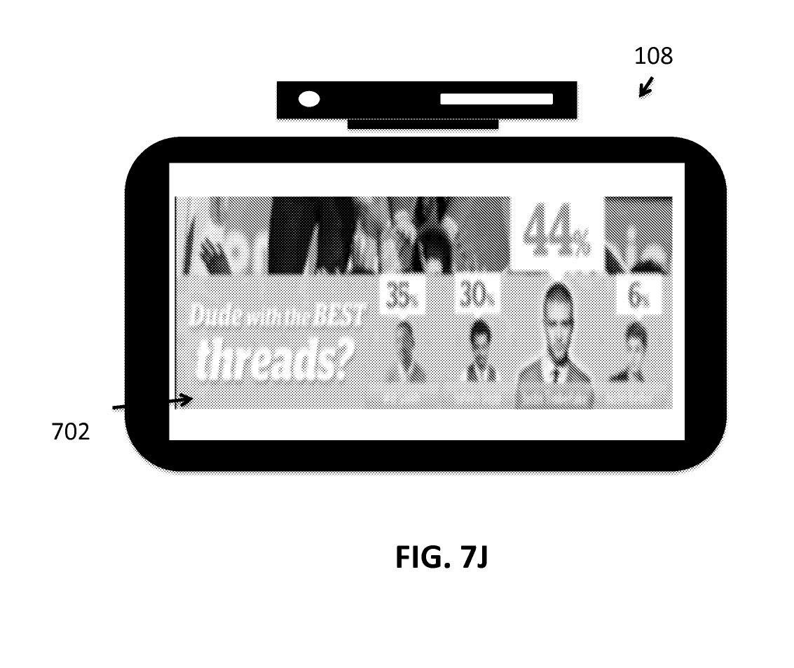

FIGS. 7A-7J illustrate exemplary television display interfaces used in the present system, according to one embodiment. An exemplary television 108 includes an area for displaying a broadcast program. The live broadcast can include one or more areas for display of content. The type of content that is displayed in these areas is determined by the mixer; that is, a typical mixer will have several inputs from various sources (cameras, graphic cards, etc.) that it mixes and outputs as a single feed. As an example, a television display 108 includes content from a primary feed 701 and a banner programming region 702 (or the system's feed). The banner region 702 may be placed in any position, at any shape and size, along with the primary content 701. It will be appreciated that the broadcaster can also choose to display the banner region 702 in the entire area of the television display 108. In FIGS. 7E-7l, the banner region 702 displays the output of the system, containing graphical elements and data-driven graphic controls. Since the outputted feed contains key and fill channels, primary content 701 is able to be displayed alongside and as part of the system content 702. In FIGS. 7H and 7l, the intelligent graphics file retrieves user-generated data from the data collection server and changes its appearance based on the collected data (e.g. real-time data indicates that Justin Timberlake has the most votes, so the intelligent graphics file changes size, color, and displays current results in real time). In FIG. 7J, system content 702 occupies the full view of the television display 108. The intelligent graphics file collects and interprets user-generated data and translates the data into a real-time action (i.e. a tug-of-war).

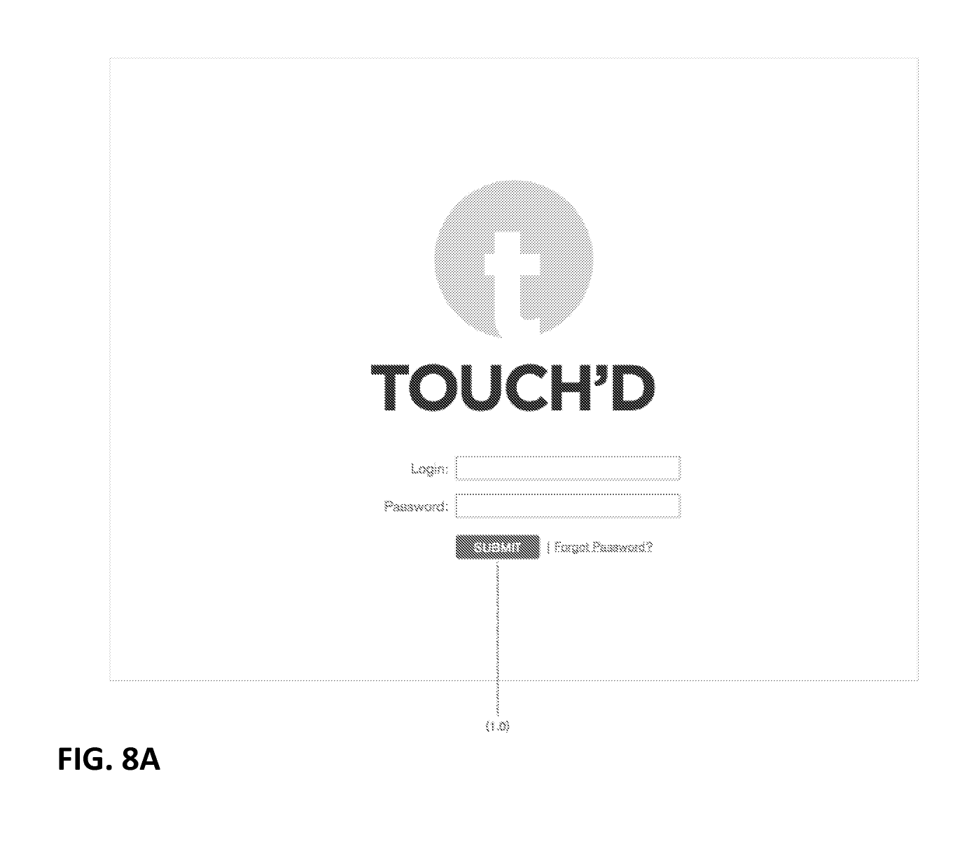

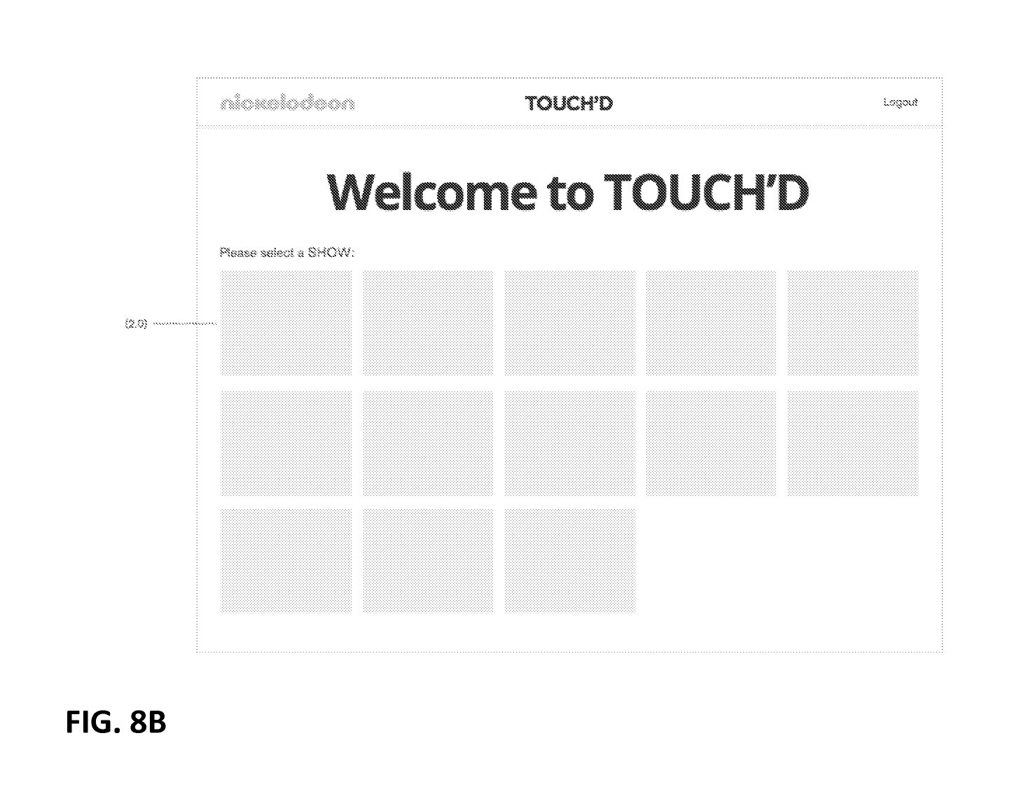

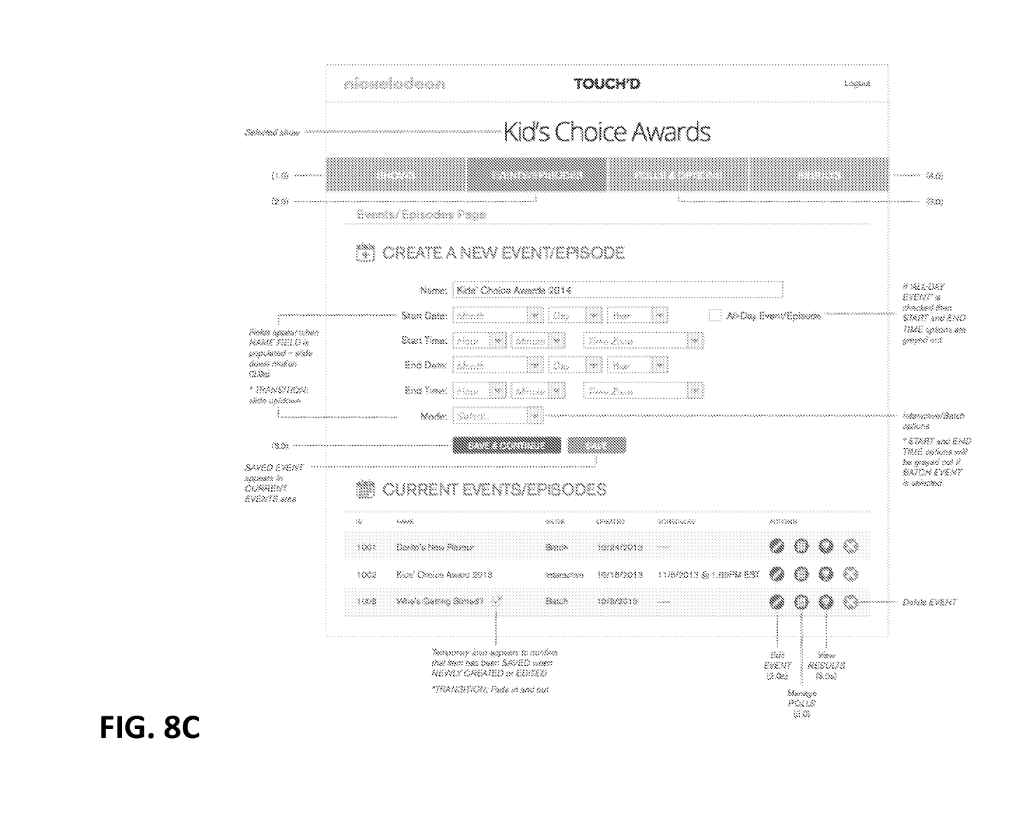

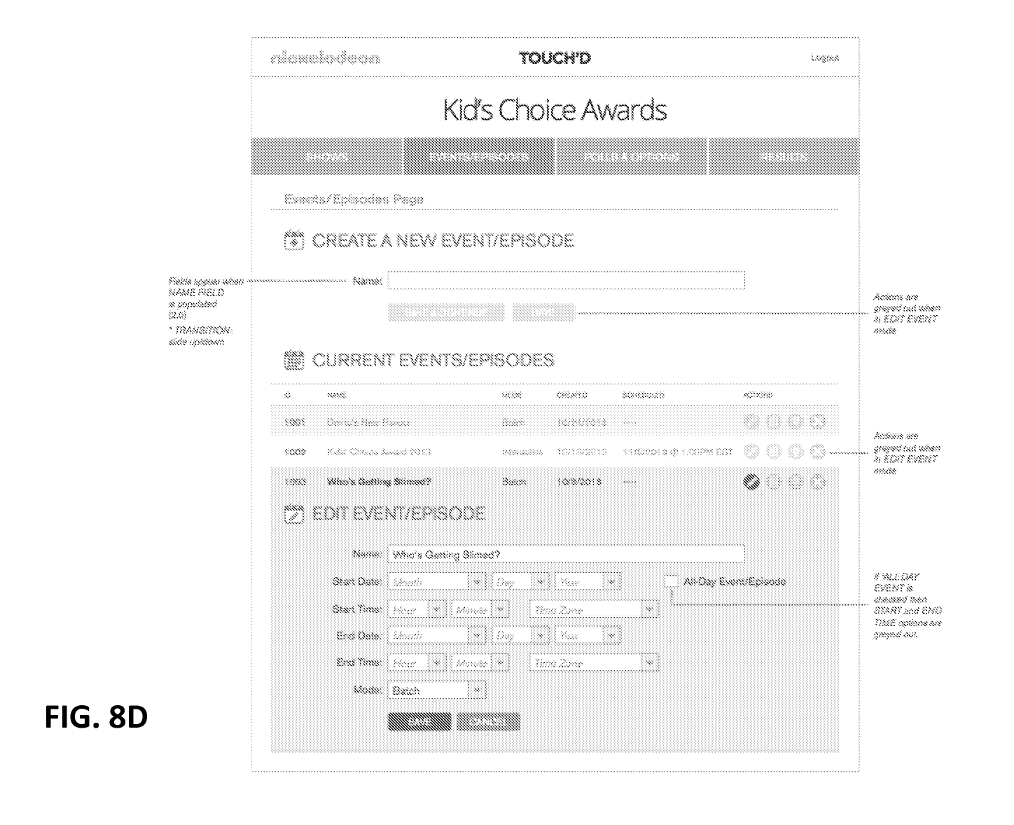

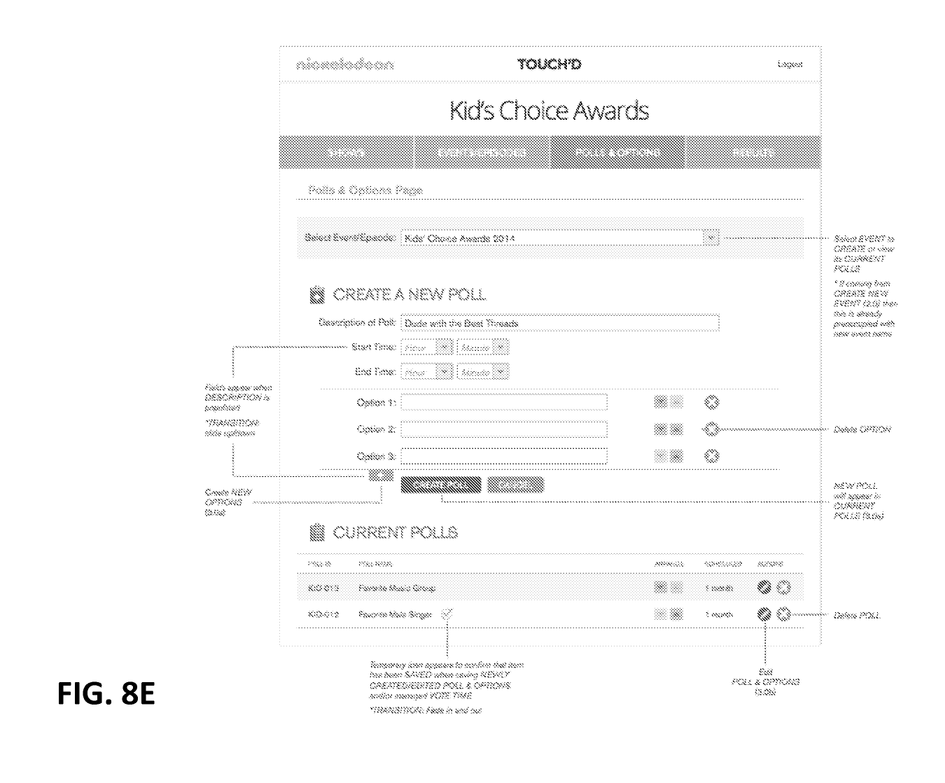

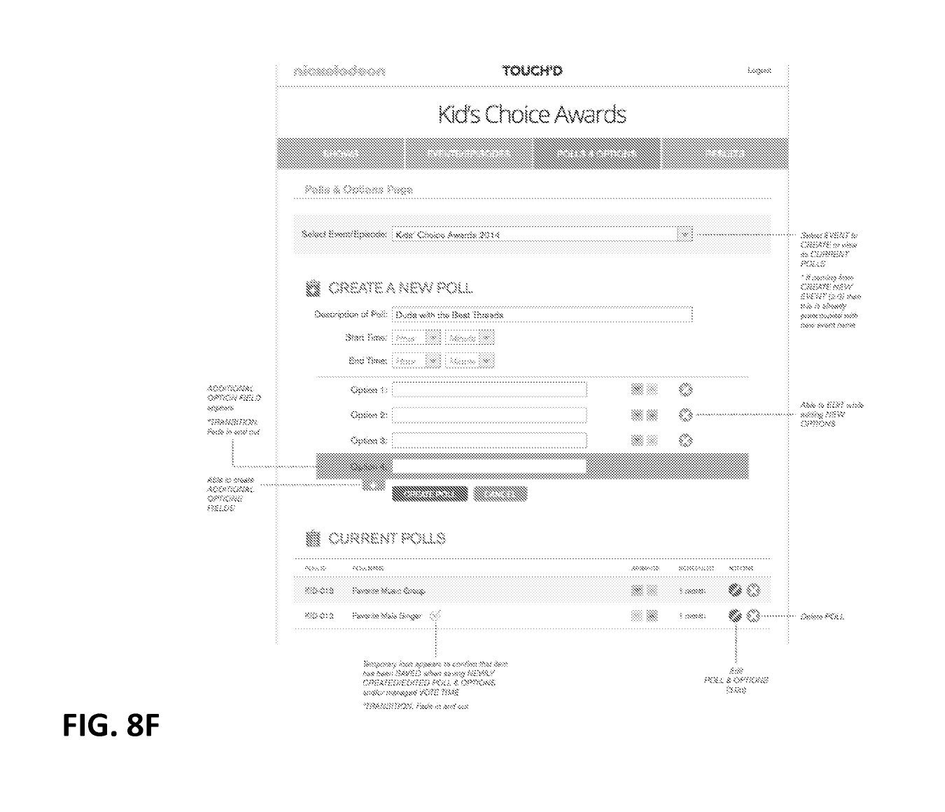

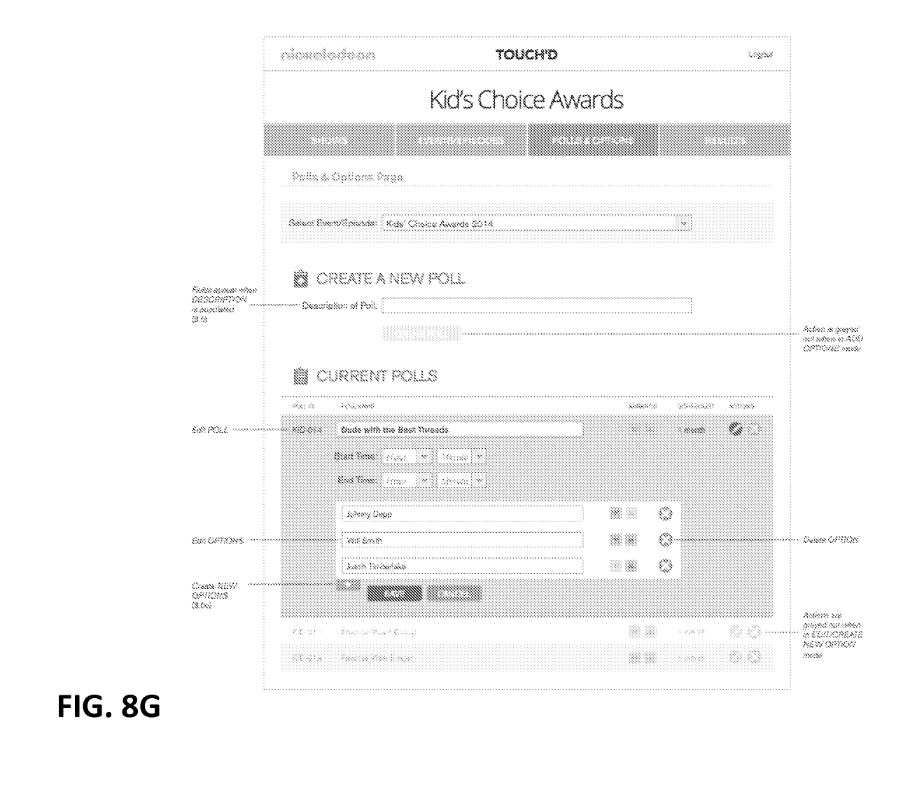

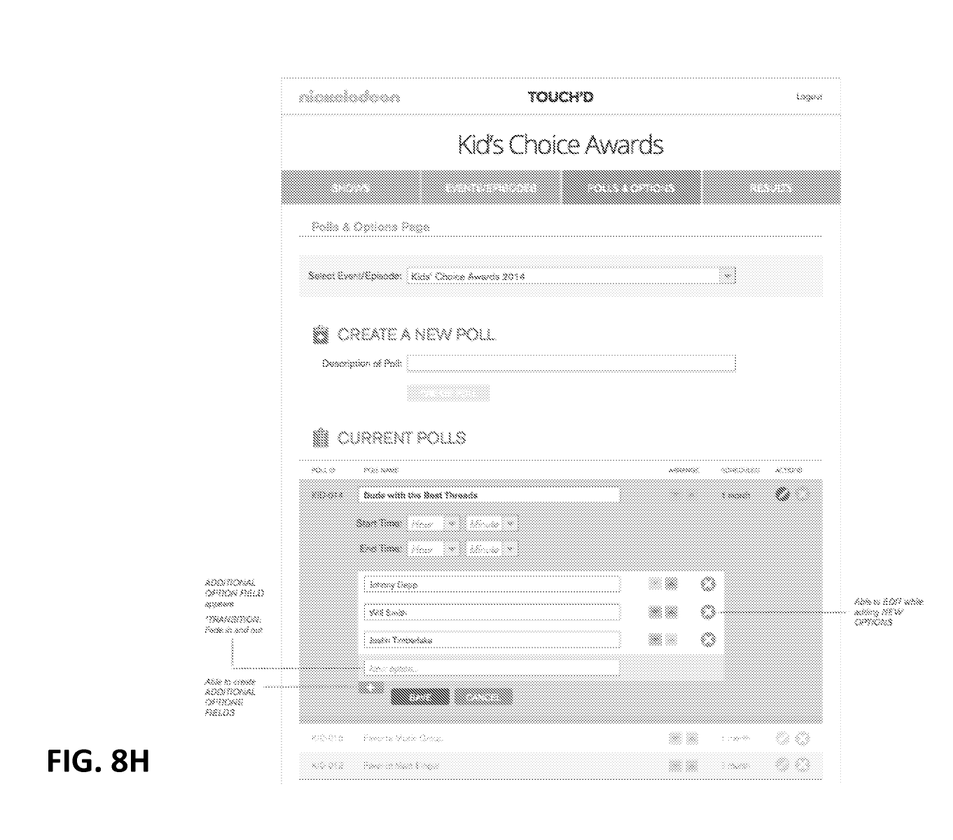

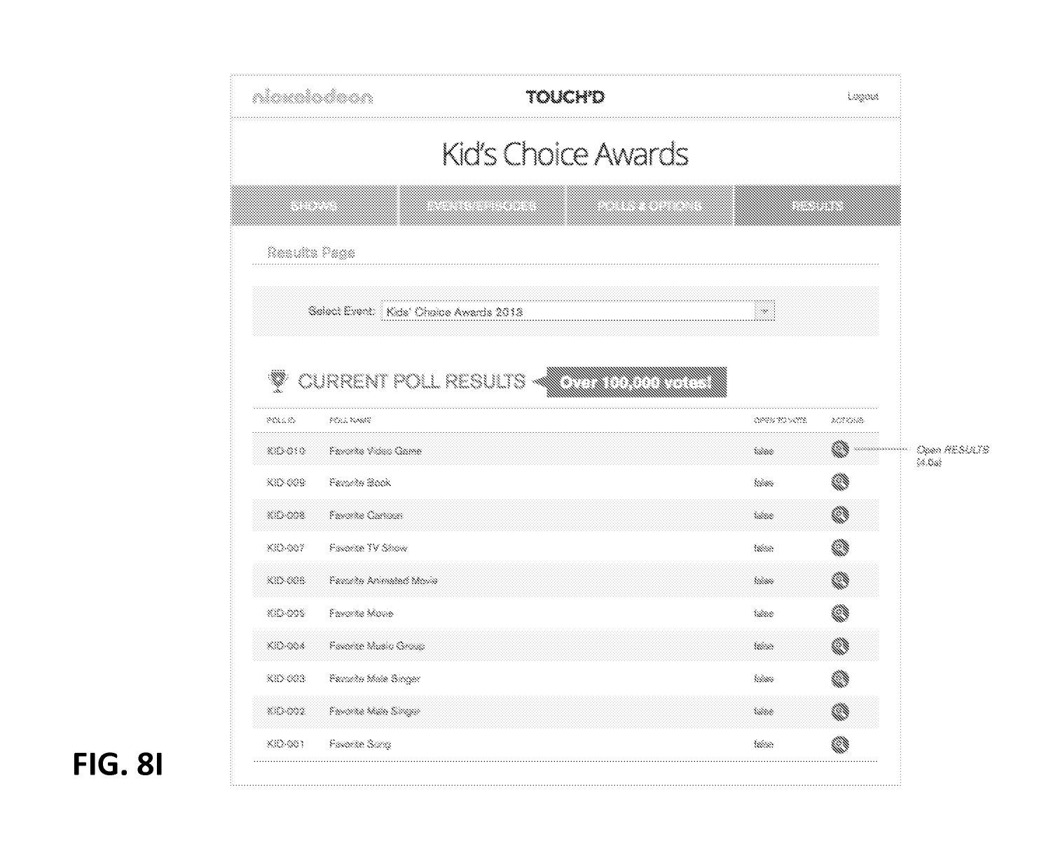

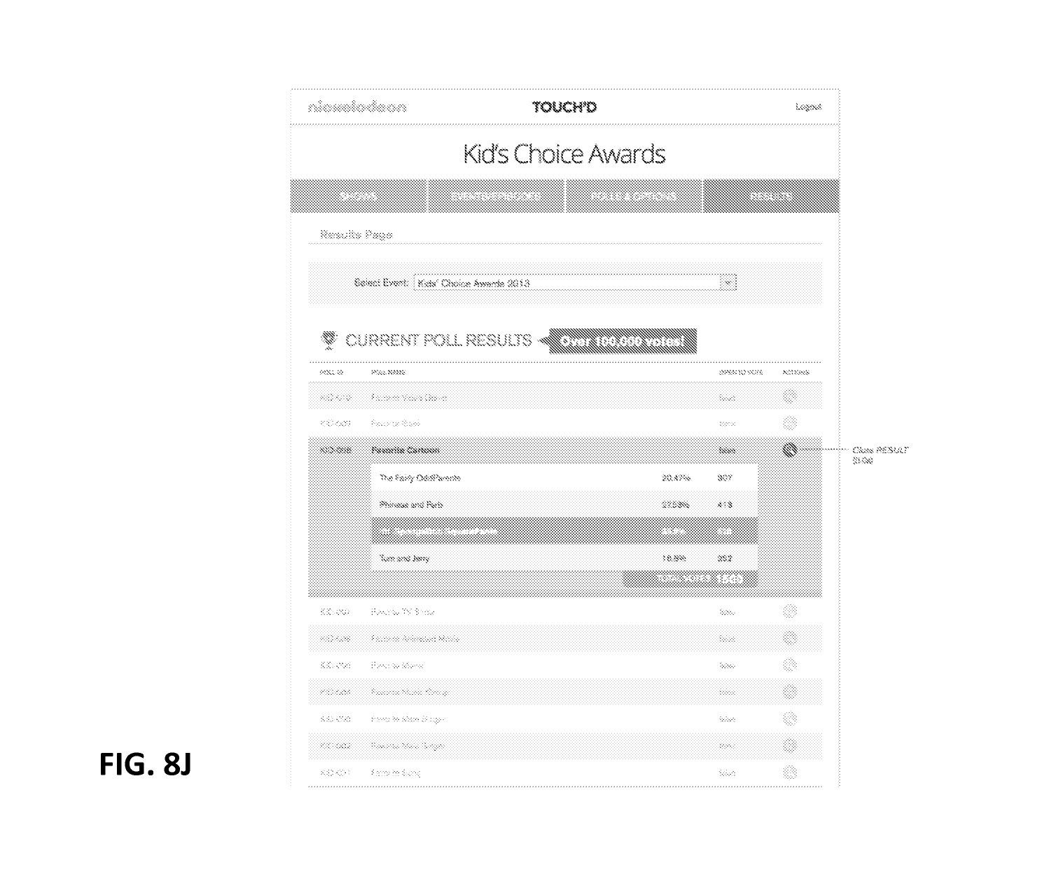

FIGS. 8A-8G illustrate exemplary administrator interfaces for use with the present system, according to one embodiment. A create poll button creates variables that enable a connection between the mobile device, data-collecting server, and the IGF. This variable creation allows for:

Defining a specific interaction within the mobile device application (e.g. vote for a specific option);

Defining the format and schema of the interaction for the data-collecting server so that the data it receives is meaningful; and

Defining the parameters whereby the IGF can perform an action (i.e. IGF logic utilizes the variable-based data collected by the data-collecting server to perform an action). For example, “if data for variable XYZ is 123, then make the on-screen visual rotate left.”)

FIG. 9 illustrates exemplary computer architecture used in the present system, according to one embodiment. One embodiment of architecture 900 comprises a system bus 920 for communicating information, and a processor 910 coupled to bus 920 for processing information. Architecture 900 further comprises a random access memory (RAM) or other dynamic storage device 925 (also referred to herein as main memory), coupled to bus 920 for storing information and instructions to be executed by processor 910. Main memory 925 also may be used for storing temporary variables or other intermediate information during execution of instructions by processor 910. Architecture 900 may also include a read only memory (“ROM”) 926 and/or other static storage device 921 coupled to bus 920 for storing static information and instructions used by processor 910.

A data storage device 925 such as a magnetic disk or optical disc and its corresponding drive may also be coupled to architecture 900 for storing information and instructions.

Architecture 900 can also be coupled to a second I/O bus 950 via an I/O interface 930. A plurality of I/O devices may be coupled to I/O bus 950, including a display device 943, an input device (e.g., an alphanumeric input device 942, such as a keyboard, and/or a cursor control device 941, such as a mouse).

The communication device 940 allows for access to other computers (e.g., servers or clients) via the internet or other network. The communication device 940 may comprise one or more modems, network interface cards, wireless network interfaces or other interface devices, such as those used for coupling to Ethernet, token ring, or other types of networks.

While the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents and alternatives falling within the spirit and scope of the appended claims.

In the description above, for purposes of explanation only, specific nomenclature is set forth to provide a thorough understanding of the present disclosure. However, it will be apparent to one skilled in the art that these specific details are not required to practice the teachings of the present disclosure.

The various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter.

It is understood that the embodiments described herein are for the purpose of elucidation and should not be considered limiting the subject matter of the disclosure. Various modifications, uses, substitutions, combinations, improvements, methods of productions without departing from the scope or spirit of the present invention would be evident to a person skilled in the art. For example, the reader is to understand that the specific ordering and combination of method actions described herein is merely illustrative, unless otherwise stated, and the invention can be performed using different or additional method actions, or a different combination or ordering of method actions. As another example, each feature of one embodiment can be mixed and matched with other features shown in other embodiments. Features and methods known to those of ordinary skill may similarly be incorporated as desired. Additionally and obviously, features may be added or subtracted as desired. Accordingly, the invention is not to be restricted except in light of the attached claims and their equivalents.

What is claimed is:

1. A system for viewers of a live broadcast to submit information for graphical display in real time on the broadcast or to modify aspects of the broadcast, the system comprising:
a user interface in the possession of a viewer, the user interface selected from the group consisting of smart phone, tablet and computer, the user interface connected to the internet and capable of transmitting information input from a viewer to a remote server through the internet connection;
a data-collecting server connected to the internet and capable of receiving information from the user interface and transforming a summary form of the information into a graphics format, and communicating the graphically formatted information to remote servers on the Internet;
a database communicating with the data-collecting server for storing information received by the data-collecting server from the user interface;
an intelligent graphics file capable of receiving information from the data-collecting server and transforming the data into graphically formatted information and actions;
a media server connected to the internet and capable of receiving the intelligent graphics from the data-collecting server, the media server capable of transforming the graphically formatted information into synchronized fill and key channels and outputting the synchronized fill and key channels; and,
a broadcast media mixer communicating with the media server and the program, the mixer capable of receiving the synchronized fill and key channels from the media server and integrating them into a portion of the screen of the displayed program;
wherein information input by a viewer to the user interface, in combination with information from other viewers, influences the portion of the screen of the displayed live broadcast.

2. The system of claim 1 wherein information input by a viewer to the user interface, in combination with information from other viewers, is displayed in a graphic format on a portion of the screen.

3. The system of claim 1 wherein information input by a viewer to the user interface, in combination with information from other viewers, modifies the program.

4. The system of claim 1 wherein the media server contains rendering software to output the synchronized fill and key channels as part of a Flash, HTML, or JavaScript file.

5. The system of claim 1 wherein the user interface is selected from the group consisting of a smart phone or tablet, and the user interface comprises an application downloaded from the internet.

6. The system of claim 1 wherein the user interface is selected from the group consisting of a laptop computer and a desktop computer, and the user interface comprises a website displayed on the computer screen.

7. The system of claim 5 wherein the system comprises over 1000 user interfaces containing the application.

8. The system of claim 7 wherein the data-collecting server is capable of being limited to receiving information from the user interfaces for only a pre-defined period of time after viewer information is solicited by the program.

9. The system of claim 8 wherein the pre-defined period of time is five minutes or less.

10. A method for viewers of a live broadcast to submit information for graphical display in real time on the live broadcast or to modify aspects of the broadcast, the method comprising the steps of:
viewers are solicited by the live broadcast to provide information to the program;
viewers provide the information to a data-collecting server through the internet by using a user interface selected from the group consisting of smart phone, tablet and computer, the user interface connected to the internet;
the viewer information received at the data-collecting server is collected and organized;
an intelligent graphics file receives viewer information from the data-collecting server and transforms the data into graphically formatted information and actions;
the intelligent graphics file is transferred to a media server;
the intelligent graphics file received at the media server is rendered as synchronized fill and key channels; and,
integrating the synchronized fill and key channels with the live broadcast to display the fill and key channels on a portion of the screen of the displayed program;
wherein information input by viewers at user interfaces is displayed in at least a portion of the screen of the displayed program.

11. The method of claim 10 wherein the synchronized fill and key channels are output from the media server to the media mixer, and wherein the synchronized fill and key channels are integrated with the live broadcast in a broadcast media mixer that receives the synchronized fill and key channels, and wherein the media mixer also controls the output signal for the live broadcast.

12. The method of claim 10 wherein the information input by viewers to the user interfaces is displayed in a graphic format on a portion of the screen.

13. The system of claim 10 wherein the information input by viewers to the user interfaces modifies the program.

14. The system of claim 11 wherein rendering software is used to output the synchronized fill and key channels from the media server to the media mixer as part of a Flash/HTML/JavaScript file.

15. The system of claim 10 wherein the user interface is selected from the group consisting of a smart phone or tablet, and the user interface comprises an application downloaded from the internet.

16. The system of claim 10 wherein the user interface is selected from the group consisting of a laptop computer and a desktop computer, and the user interface comprises a website displayed on the computer screen.

17. The system of claim 15 wherein the system comprises over 1000 user interfaces containing the application.

18. The system of claim 17 wherein the data-collecting server is capable of being limited to receiving information from the user interfaces for only a pre-defined period of time after viewer information is solicited by the program.

19. The system of claim 18 wherein the pre-defined period of time is five minutes or less.
